(19) United States
(12) Patent Application Publication
(10) Pub. No.: US 2025/0075351 A1
(43) Pub. Date: Mar. 6, 2025

(54) CATALYST

(71) Applicant: JOHNSON MATTHEY HYDROGEN TECHNOLOGIES LIMITED, London (GB)

(72) Inventors: Alejandro MARTINEZ BONASTRE, Reading Berkshire (GB); Elvis CHRISTIAN, Reading Berkshire (GB); Ricardo PAZ MOLDES DUARTE, Reading Berkshire (GB)

(21) Appl. No.: 18/727,540

(22) PCT Filed: Mar. 10, 2023
(86) PCT No.: PCT/GB2023/050563

§ 371 Date: Jul. 9, 2024

(30) Foreign Application Priority Data
Mar. 11, 2022 (GB) 2203430.0

(51) Int. Cl. C25B 11/077; C01G 53/00; C25B 9/23; C25B 13/08

(52) U.S. Cl. CPC C25B 11/077; C01G 53/40; C25B 9/23; C25B 13/08; C01P 2002/72; C01P 2002/76; C01P 2002/85; C01P 2004/64; C01P 2006/40

(57) ABSTRACT

Nickel-cobalt-oxide materials of formula NixCo3-xO4-α, in which 0.5≤x≤2.0 and 0≤α≤1.0. The nickel-cobalt-oxide materials have a cobalt-enriched surface composition and the ratio of Co to Ni at the surface is greater than or equal to 3.0 as determined by XPS measurement. Such materials have utility as oxygen evolution catalysts, for example for water electrolysis.

### FIELD OF THE INVENTION

The present invention relates to nickel-cobalt-oxide materials and their use as catalysts for oxygen evolution, for example in a water electrolyser.

### BACKGROUND OF THE INVENTION

The electrolysis of water to produce high purity hydrogen and oxygen can be carried out in both alkaline and acidic electrolyte systems and practical devices using both types of electrolyte systems exist as commercial products.

One type of electrolysis which utilises an alkaline electrolyte is liquid alkaline electrolysis. Liquid alkaline electrolysis is characterised by two electrodes separated by a diaphragm and operating in a liquid alkaline electrolyte solution, such as a solution of potassium hydroxide or sodium hydroxide.

Commercial electrolysers have also been developed which employ an anion exchange membrane (AEM). Such anion exchange membranes allow hydroxide anions to move through the membrane from the cathode to the anode during the hydrogen generation process. Electrolysers employing such a membrane may be known as AEM water electrolysers.

During water electrolyser operation the oxygen evolution reaction (OER) takes place at the anode and the hydrogen evolution reaction (HER) takes place at the cathode, in alkaline conditions these reactions are approximated by the following equations:

$$4 O \text{H-} = {O}_{2} + 2 {H}_{2} O + 4 e - ( O ER )$$

$$2 {H}_{2} O + 2 e - = {H}_{2} + 2 O \text{H-} ( HER )$$

NiCo₂O₄ spinel materials are known as bifunctional oxygen electrocatalysts. For example, the activity of NiCo₂O₄ as a catalyst for oxygen evolution and oxygen reduction is described in Thompson S. J. et al., Electrochimica Acta 188 (2016) 286-293.

It is also described in Singh, P., RSC Adv., 2020, 10, 17845 that Co₁₋ₓNiₓO materials are electrocatalysts for the oxygen evolution reaction. The formed materials have the same bulk and surface composition.

The remains a need to provide improved catalysts with enhanced catalytic activity, for example to improve the efficiency of oxygen evolution in electrochemical applications, such as water electrolysis.

### SUMMARY OF THE INVENTION

The present inventors have surprisingly found that by altering the ratio of metal elements at the surface of nickel-cobalt-oxide materials the balance between oxygen evolution and oxygen reduction may be altered and catalysts with high OER activity may be produced.

Therefore, in a first aspect of the invention there is provided a nickel-cobalt-oxide material of formula (1):

NiₓCo₃₋ₓO_{4-α} (1)
in which 0.5≤x≤2.0 and 0≤α≤1;
and wherein the nickel-cobalt-oxide material has a cobalt-enriched surface composition and the ratio of Co to Ni at the surface is greater than or equal to 3.0 as determined by X-ray photoelectron spectroscopy (XPS) measurement.

It has been found that such materials may be prepared using flame-spray pyrolysis. Therefore in a second aspect of the invention there is provided a process for manufacturing a nickel-cobalt-oxide material according to the first aspect, the process comprising the steps of:
(i) providing a precursor solution comprising a nickel-containing precursor and a cobalt-containing precursor;
(ii) subjecting the precursor solution to flame spray pyrolysis to produce the nickel-cobalt-oxide material.

It has been found that the nickel-cobalt oxide materials of the first aspect have a high catalytic activity for the oxygen evolution reaction. Therefore, in a third aspect of the invention there is provided the use of a nickel-cobalt-oxide material according to the first aspect as a catalyst for oxygen evolution.

Such materials may be formed into an electrode and find utility in applications such as water electrolysis. Therefore, in a fourth aspect of the invention there is provided the use of a nickel-cobalt-oxide material according to the first aspect as a catalyst in a water electrolyser, such as an anion exchange membrane (AEM) water electrolyser.

In a fifth aspect of the invention there is provided an electrode for water electrolysis, such as an electrode for liquid alkaline electrolysis or an electrode for AEM electrolysis, comprising a nickel-cobalt-oxide material according to the first aspect.

In a sixth aspect of the invention there is provided a membrane electrode assembly, such as a catalyst coated membrane, comprising a nickel-cobalt-oxide material according to the first aspect or an electrode according to the fifth aspect.

In a seventh aspect of the invention there is provided a water electrolyser comprising an electrode according to the fifth aspect, or a membrane-electrode assembly according to the sixth aspect.

The nickel-cobalt oxide materials may also be incorporated into a fuel cell, for example to improve cell reversal tolerance. Therefore, in an eighth aspect of the invention there is provided a fuel cell comprising a nickel-cobalt-oxide material according to the first aspect.

### BRIEF DESCRIPTION OF THE FIGURES

FIG. 1 shows a schematic illustration of a flame spray pyrolysis apparatus.

FIG. 2 shows cobalt and nickel XPS analysis of the materials produced in Comparative Example 3 (with an oxygen flow rate of 15 mL/min) and Example 1 (with an oxygen flow rate of 30 mL/min).

FIG. 3 shows the results of XRD analysis of the materials produced in Comparative Example 3 and Example 1.

FIG. 4 shows a schematic illustration of the PTFE three electrode cell employed for electrochemical testing.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The present invention provides nickel-cobalt-oxide materials of Formula (1) as defined above.

In Formula 1, 0.5<x≤2.0. It may be preferred that 0.6≤x≤1.8, 0.7≤x≤1.5, 0.8≤x≤1.2, 0.9≤x≤1.1, or that x is about 1.0 or equal to 1.0.

In Formula 1, 0≤α≤1.0. It may be preferred that 0≤α≤0.9, 0≤α≤0.7, 0≤α≤0.5, 0≤α≤0.4, 0≤α≤0.3, 0≤α≤0.2, 0≤α≤0.1, 0≤α≤0.05, or that α=0. It may be further preferred that 0.1≤α≤1.0, 0.3≤α≤1.0, 0.5≤α≤1.0, 0.6≤α≤1.0, 0.7≤α≤1.0, 0.8≤α≤1.0, 0.9≤α≤1.0, or that α=1.

The nickel-cobalt-oxide materials have a cobalt-enriched surface composition. As used herein the term “cobalt enriched surface composition’ means that the composition of the material at the surface has a greater concentration of cobalt than is present in bulk composition of the material. The surface composition may be determined by XPS analysis, and the bulk composition may be determined by inductively coupled plasma-optical emission spectrometry (ICP-OES) analysis as set out herein.

Cobalt-enrichment of the surface layer has been shown to provide high oxygen evolution activity whilst enabling a reduction in the overall cobalt content of catalyst materials which is desirable since cobalt can be a significant contribution to the cost of the materials (due to its high relative cost and historic price volatility), and because it may be preferable to reduce cobalt content for ethical reasons.

The ratio of Co to Ni at the surface of the nickel-cobalt-oxide material is greater than or equal to 3.0 as determined by XPS measurement. The ratio of Co to Ni may be calculated from the Co 2p_{1/2} and Ni 2p_{3/2} peaks of the XPS spectra of the material. The integration of the peaks, normalisation using sensitivity factors, and calculation of the ratio may be determined using standard XPS software packages, for example using Thermo Scientific Advantage XPS software.

It may be preferred that the ratio of Co to Ni at the surface of the nickel-cobalt-oxide material is greater than or equal to 3.1, greater than or equal to 3.2, greater than or equal to 3.3, greater than or equal to 3.4, or greater than or equal to 3.5. It may be preferred that the ratio of Co to Ni at the surface of the nickel-cobalt-oxide material is less than or equal to 6.0, less than or equal to 5.5, less than or equal to 5.0, less than or equal to 4.8, less than or equal to 4.6, less than or equal to 4.5, less than or equal to 4.4, or less than or equal to 4.2. It may be preferred that the ratio of Co to Ni at the surface of the nickel-cobalt-oxide material is in the range of and including 3.0 to 6.0, 3.0 to 5.5, 3.0 to 5.0, such as 3.3 to 4.3, or 3.5 to 4.5.

Typically, the bulk ratio of Co to Ni of the nickel-cobalt-oxide material is less than 2.5. The bulk ratio of Co:Ni may be determined by ICP analysis and is calculated by dividing the measured Co at % value by the measured Ni at % value.

It may be preferred that the bulk ratio of Co to Ni of the nickel-cobalt-oxide material is less than or equal to 2.4, less than or equal to 2.3, or less than or equal to 2.2. It may be preferred that the bulk ratio of Co to Ni of the nickel-cobalt-oxide material is greater than or equal to 0.5, greater than or equal to 0.7, greater than or equal to 1.0, greater than or equal to 1.3, greater than or equal to 1.5, or greater than or equal to 1.8. It may be preferred that the bulk ratio of Co to Ni of the nickel-cobalt-oxide material is in the range of and including 2.5 to 0.5, such as 2.5 to 1.0, or 2.5 to 1.5.

Preferably, the ratio of Co to Ni at the surface is greater than the bulk ratio of Co to Ni. Preferably, the value for the ratio of Co to Ni at the surface is at least 0.1 higher than the value for the bulk ratio of Co to Ni. It may be preferred that the difference in the ratio is at least 0.2, at least 0.3, at least 0.4 or at least 0.5. It may be preferred that the Co to Ni ratio at the surface of the nickel-cobalt-oxide material is greater than or equal to 3.0 and the bulk ratio of Co to Ni is less than or equal to 2.5. It may be further preferred that the Co to Ni ratio at the surface of the nickel-cobalt-oxide material is in the range of and including 3.0 to 5.0, and the bulk ratio of Co to Ni is in the range of and including 0.5 to 2.5.

Typically, the nickel-cobalt-oxide materials have a structure corresponding to the Fm-3m space group as determined by x-ray diffraction analysis (XRD). As used herein, ‘structure corresponding to the Fm-3m space group’ means that this is the main phase determined by XRD analysis and does not preclude the presence of additional minor phases corresponding to, for example, spinel structures, or the presence of amorphous material. It may be preferred that at least 70% of the identified crystalline phases by XRD have a structure corresponding to the Fm-3m space group, for example at least 80%, at least 90% or at least 95%. The proportion of crystalline phases may be determined by measuring peak integrals following Rietveld refinement of the XRD data.

Typically, the nickel-cobalt-oxide materials have a Co²⁺ oxidation state at the surface. The surface oxidation state may be determined by analysis of the Co 2p3/2 satellite features in the XPS pattern. The satellite features are analysed by comparison with benchmarking studies such as that set out in Smart, R.; Applied Surface Science 257 (2011) 2717-2730.

Typically, the nickel-cobalt-oxide materials are in particulate form. The particles may have a mean particle size in the range of and including 1 to 200 nm, for example in the range of and including 1 to 150 nm, 1 to 100 nm, 1 to 50 nm, or 5 to 50 nm. The mean particle size may be determined by transmission electron microscopy (TEM). For example, the mean particle size may be determined by analysing the material by TEM and then calculating the arithmetic mean of measurements of the diameter of a randomly selected set of at least 20 particles.

The nickel-cobalt-oxide materials may be provided in the form of a composition comprising, or consisting of, a nickel-cobalt-oxide material as described herein and carbon. Typically, the carbon content of such compositions is in the range of and including 1 to 20 wt % based on the total weight of the composition. It may be preferred that the carbon content is in the range of and including 1 to 15 wt %, or in the range of and including 5 to 15 wt %. The carbon content may be determined using a CHN analyzer, such as a CE440 ElementalAnalyser.

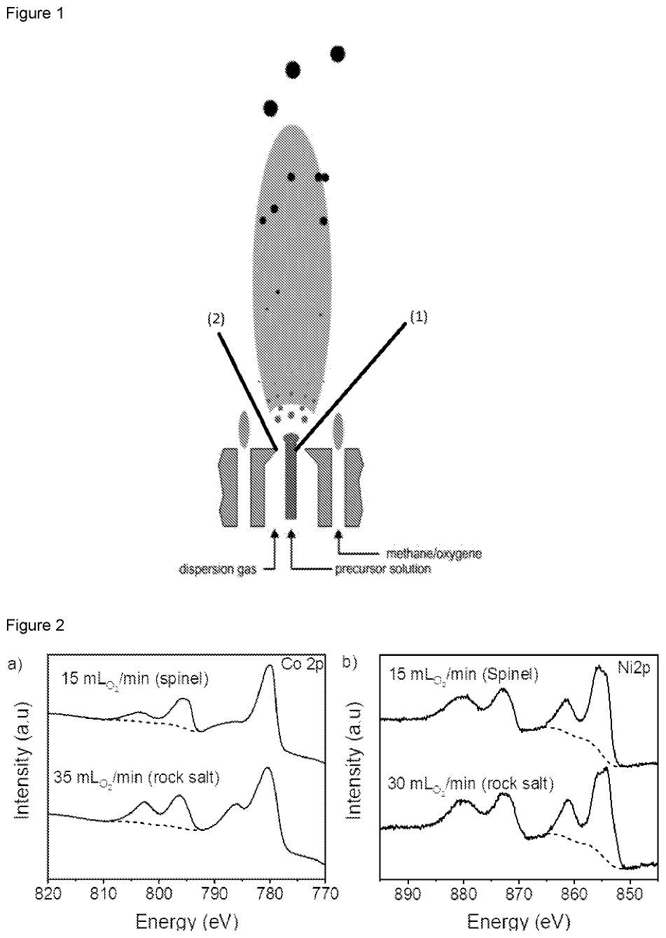

The materials as described herein may be produced by subjecting a solution of precursors to flame spray pyrolysis. Flame spray pyrolysis is known in the art, and is described in R. Strobel, S. E. Pratsinis, Journal of Materials Chemistry 2007, 17, 4743-4756. During flame spray pyrolysis, the precursor solution is aerosolised with a dispersing gas, typically oxygen or air, within a chamber and then ignited, typically using a hydrogen or methane pilot flame. Referring to FIG. 1, the precursor solution is typically aerosolised by pumping the precursor solution through a fluid nozzle (1) and dispersing gas through a gas nozzle (2). In many flame spray pyrolysis processes, the solvent of the precursor solution typically provides the “fuel” for the combustion. Without being bound by theory, it is considered that the aerosol undergoes rapid combustion within milliseconds, oxidising all of the organic components and leaving predominantly inorganic species (e.g. metal-oxyanions) in the gas phase. These oxyanions thereafter nucleate to form clusters and finally nano-sized particles. The temperature of the gas cools rapidly, typically leading to kinetic products and nanopowders that are non-aggregated. The resultant nanopowders may be collected by any suitable means, for example in a filter (e.g. by a filter sock system).

Flame spray pyrolysis rigs are known in the art. The flame spray pyrolysis rig may include a secondary quenching ring. Such a quenching ring typically comprises a ring or tube of gas, typically nitrogen, which surrounds the downstream path of the particles exiting the flame. This may serve to increase the cooling rate of the particles, thereby resulting in a smaller particle size. A sheath gas may be employed during the flame spray pyrolysis. The use of a sheath gas is known in the art. An oxygen sheath gas may be employed, for example to maintain the required level of oxygen during the flame spray pyrolysis step so as to obtain the desired product.

Any suitable solvent may be used for the precursor solution. The choice of solvent will depend on the solubility of the precursors therein and also the desired size of particles of the nickel-cobalt-oxide materials. Solvents exhibiting lower heats of combustion, and therefore providing lower flame temperatures in the flame spray pyrolysis step, typically result in smaller particle sizes being produced. In contrast, solvents exhibiting higher heats of combustion, and therefore providing higher flame temperatures in the flame spray pyrolysis step, typically result in larger particle sizes being produced. A mixture of different solvents may be employed in order to fine tune the resulting particle sizes.

The solvent may be a polar solvent or a non-polar solvent. Depending on the particular precursors employed, a polar or non-polar solvent may be chosen so as to result in a stable precursor solution. The solvent may be an organic solvent or an inorganic solvent, but is typically an organic solvent. In contrast to inorganic solvents, organic solvents typically function more effectively as fuels during the flame spray pyrolysis step. To improve combustion, the solvent is typically substantially free of water, more typically it is anhydrous. However, water may be present in order to decrease the heat of combustion, and therefore decrease the size of the resulting particles.

The precursor solution preferably comprises a solvent selected from one or more of acetic acid, methanol, ethyl acetate, ethanol, acetonitrile, acetone, acetylacetone, 1-propanol, 1-butanol, 2-ethylhexanoic acid, hexane, heptane, 1-octanol, octane, cyclohexane, toluene and xylene. Such solvents exhibit favourable heats of combustion, and/or are capable of dissolving a wide variety of precursors. Mixtures of methanol and 2-ethylhexanoic acid may be particularly preferred.

A variety of cobalt-containing precursors may be employed. The cobalt-containing precursors may be inorganic or organometallic. Suitable cobalt-containing precursors include cobalt salts, such as inorganic cobalt salts or cobalt oxides. Preferably, the cobalt-containing precursor is a cobalt-containing compound in which the cobalt is in the +2 oxidation state. Preferably the cobalt-containing compound is cobalt (II) acetate, cobalt (II) nitrate, cobalt (II) pentanedionate, or cobalt (II) acetylacetonate. Cobalt (II) acetate may be particularly preferred.

A variety of nickel-containing precursors may be employed. The nickel-containing precursors may be inorganic or organometallic. Suitable nickel-containing precursors include nickel salts, such as inorganic nickel salts or nickel oxides. Preferably, the nickel-containing precursor is a nickel-containing compound in which the nickel is in the +2 oxidation state. Preferably the nickel-containing compound is nickel (II) acetate, nickel (II) nitrate, nickel (II) pentanedionate, or nickel (II) acetylacetonate. Nickel (II) acetate may be particularly preferred.

It may be preferred that:
the solvent comprises methanol and/or 2-ethylene hexanoic acid;
the nickel precursor is nickel (II) acetate;
the cobalt precursor is cobalt (II) acetate.

In a typical process according to the present invention, the amounts of the different precursors in the precursor solution are selected according to the composition of the desired product. For example, if NiCo₂O_{4-α} is to be obtained, nickel and cobalt compounds are combined in the precursor solution in a 1:2 molar ratio.

In the flame spray pyrolysis step, it is possible to vary the flow of precursor aerosol into the chamber by varying the flow rate of the dispersing gas and/or the precursor solution. The present inventors have found that it may be advantageous to control the ratio of precursor solution feed rate to dispersion gas flow rate. Preferably, the dispersing gas flow rate:precursor solution flow rate is at least 6.5:1, or at least 7:1. It may be preferred that the dispersing gas flow rate:precursor solution flow rate is in the range of and including 6.5:1 to 20:1.

During the flame spray pyrolysis, the formed particles are typically collected using techniques know in the art. The particles are preferably collected by electrophoretic deposition or by a filter. Such collection techniques are particularly suitable.

The nickel-cobalt-oxide materials may be used as an oxygen evolution reaction catalyst, for example for water electrolysis, such as liquid alkaline electrolysis or AEM electrolysis, in particular in the anode of a water electrolyser utilising an alkaline electrolyte, such as a liquid alkaline electrolyser or an AEM electrolyser.

AEM water electrolysers typically comprise a membrane electrode assembly (MEA). Such MEAs comprise an ion exchange membrane with (i) a cathode comprising a hydrogen evolution catalyst on one side, and (ii) an anode comprising an oxygen evolution catalyst on the other side. A gas diffusion layer may be provided adjacent to each electrode. The membrane is typically a polymeric membrane which is permeable to hydroxide ions. Such membranes are known to the person skilled in the art.

In some embodiments of the present invention, there is provided an electrode for a water electrolyser comprising a nickel-cobalt-oxide material as described herein. In further embodiments of the invention there is provided an MEA, such as an MEA for an AEM water electrolyser, comprising a nickel-cobalt-oxide material as described herein. Typically, the nickel-cobalt-oxide material is provided in the anode of the MEA. The material may act as an oxygen evolution catalyst in such an arrangement.

It may be preferred that the MEA comprises a catalyst coated membrane (CCM). Such a CCM comprises a membrane (such as an anion exchange membrane) having an anode catalyst layer on a first face thereof and/or a cathode catalyst layer on a second face thereof. In such an arrangement, the anode catalyst layer comprises a nickel-cobalt-oxide material as described herein.

The nickel-cobalt-oxide material may be formulated as an ink, typically by dissolving or dispersing the catalyst in a mixture of a fluoropolymer (such as Nafion®) and water. The inks may be applied on an ion exchange membrane to produce the anode catalyst layer of a catalyst coated membrane. The CCM may include additional components (e.g. recombination catalysts, reinforcements, multiple layers) as will be known to those skilled in the art.

The present invention will now be described with reference to the following examples, which are provided to assist with understanding the present invention and are not intended to limit its scope.

### EXAMPLES

### Example 1—Preparation of NiCo₂O₄ Using Flame Spray Pyrolysis

A solution of nickel (II) acetate (9.98 g) and cobalt (II) acetate (19.81 g) (1:2 molar ratio) were dissolved in a mixture of methanol (178 mL) and 2-ethylhexanoic acid (55 mL). A nickel-cobalt-oxide material was prepared by flame spray pyrolysis (precursor solution flow rate of 5 mL/min through a fluid nozzle of 0.5 mm diameter, oxygen flow rate of 35 mL/min though a dispersing gas nozzle of 1.6 mm diameter, ratio dispersing gas flow rate:precursor solution flow rate 7:1). The flame temperature was kept below 200° C. A 1.4 bar pressure drop across the tip was recorded.

### Comparative Example 1

A sample of nickel cobalt oxide was purchased from Sigma Aldrich CAS [58591-45-0], product no. 634360.

### Comparative Example 2

A sample of NiCo₂O₄ was prepared by a co-precipitation process according to the method of Russel, A. E., Journal of The Electrochemical Society, 163 (10), H884-H890 (2016).

### Comparative Example 3

The method of Example 1 was repeated with a precursor solution flow rate of 5 mL/min and oxygen flow rate of 15 mL/min (dispersing gas flow rate:precursor solution flow rate 3:1).

### Analysis of Bulk Composition by Inductively Coupled Plasma—Optical Emission Spectrometry (ICP-OES)

The elemental composition of the compounds was measured by ICP-OES. For that, approximately 0.05 g of material are digested using 10 ml aqua regia (3:1 ratio of hydrochloric acid and nitric acid) in a high-performance microwave at ˜130° C. and 110 bar pressure. The resulting digests were made up to 100 mL in volumetric flasks and spiked with yttrium solution to be used as an internal standard. The diluted solutions were analysed using an Agilent 5110 ICP-OES using matrix matched calibration standards, the levels of which were determined by the expected elemental concentration of analytes. Interference free lines were selected from the ICP-OES to ensure the validity of the data reported.

The Results of ICP Analysis are Provided in Table 1. Each of the Materials has a Similar Bulk Composition with a Co:Ni Ratio of Around 2.

TABLE 1
Results of ICP-OES analysis of bulk composition

| Sample | Bulk Co:Ni |
|---|---|
| Example 1 | 1.8 |
| Comparative Example 1 | 2.0 |
| Comparative Example 2 | 2.0 |
| Comparative Example 3 | 2.0 |

Analysis by x-Ray Photoelectron Spectroscopy (XPS)

The materials of Example 1 and Comparative Examples 1 to 3 were analysed by XPS. The analysis was carried out using a Thermo Escalab 250. The radiation used was monochromatised aluminium Kα radiation with a 650 μm spot size. Charge compensation was provided by the in-lens electron flood gun at a 2 eV setting and the “401” unit for “zero energy” argon ions. Powdered samples were analysed by pressing a carbon tape onto a given amount of oxide powder. The tape was then mounted onto a stainless-steel stub which served as support during the measurement. Thermo Scientific Avantage XPS software was used to process XPS data, where charge correction was performed so that the C-C peak would be positioned at 284.8 eV. Co:Ni ratios at the surface were determined using the software by integrating the Co 2p_{1/2} and Ni2p_{3/2} peaks, normalising using sensitivity factors available in the software package, and calculating the ratio. The results are shown in Table 2 which indicates that the material formed in Example 1 has a cobalt-enriched surface composition and a significantly higher cobalt content at the surface in comparison to the comparative examples. The XPS results for Comparative Example 3 and Example 1 are also shown in FIG. 2. The Co 2p_{3/2} signal indicates that the surface structure of Comparative Example 3 is a spinel structure, and the surface structure of Example 1 is a rock salt structure.

TABLE 2
Results of XPS analysis

| Sample | Surface Co:Ni |
|---|---|
| Example 1 | 3.8 |
| Comparative Example 1 | 2.1 |
| Comparative Example 2 | 1.3 |
| Comparative Example 3 | 2.2 |

Analysis by Powder x-Ray Diffraction (XRD)

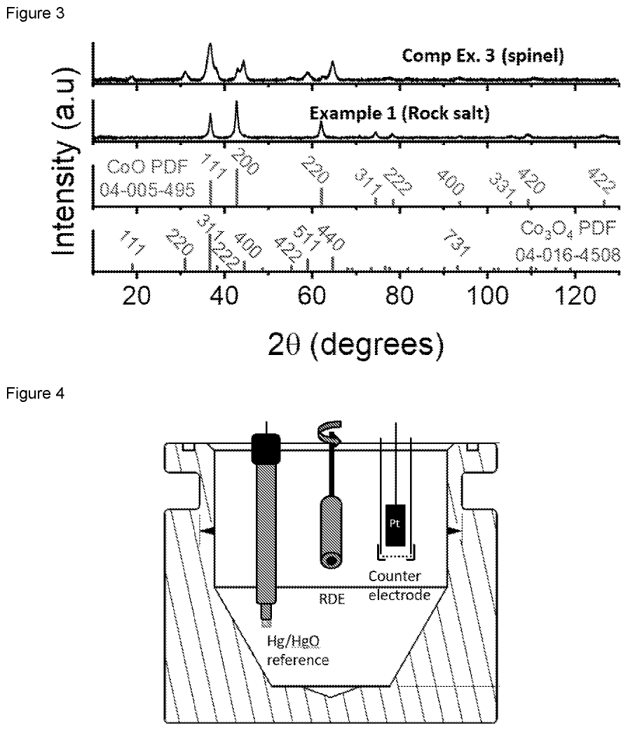

The samples were analysed by XRD using a Bruker AXS D8 in reflection mode using Cu K_{α} (γ=1.5406+1.54439 Å) radiation at ambient temperature. Phase identification was carried out using Bruker AXS Diffrac Eva V5 (2010-2018) software and the PDF-4+ (Release 2020) database. Rietveld analysis was carried out with a complete-powder diffraction pattern fitting technique using a full structural model. Pawley analysis was used to fit data for which a degree of uncertainty exists as to the exact nature of the structure. FIG. 3 shows the XRD pattern for Example 1 and Comparative Example 3 together with references patterns for rock salt and spinel structures. Table 2 shows the result of phase identification carried out on the generated XRD data.

TABLE 2
Space group of the major phase identified by XRD analysis.

| Sample | Space group |
|---|---|
| Example 1 | Fm-3m |
| Comparative Example 1 | Fm-3m |
| Comparative Example 2 | Fd-3m |
| Comparative Example 3 | Fd-3m |

### Measurement of Particle Size

Particle size was measured by transmission electron microscopy. An image was taken of the powder and the diameter of a randomly selected set of at least 20 particles was measured. The arithmetic mean value of the particle size was calculated. The results are shown in Table 3.

TABLE 3
Results of particle size analysis

| | Mean particle | No. of particles |
|---|---|---|
| Sample | size (nm) | measured |
| Example 1 | 15 | 23 |
| Comparative Example 1 | 54 | 105 |
| Comparative Example 2 | 40 | 141 |
| Comparative Example 3 | 15 | 26 |

### Determination of Electrochemical Activity

Electrode preparation: A glassy carbon rotating disk electrode (RDE) was polished in a micropolishing cloth with 0.3 and 0.05 μm Al₂O₃ suspension (Buehler). After each polishing step, the tip of the RDE was sonicated and rinsed in mQ water. Water dispersed NiCo₂O₄ inks were prepared with concentrations of 0.5 mg_{catalyst}/mL and 0.1 mg_{FAA-3}/ML employing an FAA-3 anion exchange ionomer (Fumatech). KOH (Suprapur) was used to prepare the inks and electrolyte. 10 μL of the given ink were drop cast onto a polished glassy carbon RDE and dried with an infra-red lamp.

Cell assembly: A PTFE rotating disk electrode set up (Pine Instruments) with a glass-free Hg/HgO reference electrode (Pine Instruments) and a PTFE frit as gas bubbler (Bohlender GmbH) was used. A Pt counter electrode was used and separated by an anion exchange membrane (Fumatech) using an in-house, designed membrane holder made of PTFE, as shown in FIG. 4. All labware in contact with electrolyte, except reference and rotating disk electrodes were cleaned by immersing in a bath of NOCHROMIX cleaning agent, dissolved in <95% H₂SO₄ (Fischer Scientific) overnight. Labware was then rinsed six times and boiled in ultrapure water (Milipore 18.2Ω). A clean PFA volumetric flask (VWR) was used to prepare the electrolyte, thus preventing contamination from corrosion of glass when in contact with 0.1 M KOH.

Determination of electrochemical activity: NiCo₂O₄ catalyst activity was measured by first measuring ORR activity, by cyclic voltammetry at 10 mV/s between 1-0.6 V_{RHE}, and then measuring OER activity, by cyclic voltammetry between 1-1.7 V_{RHE}. IR correction was employed at 80% during all the measurements, and the resistance was determined by electrochemical impedance spectroscopy. The value for the ohmic resistance was determined by linear fitting the low frequency region and taking the intercept with the x-axis in a Nyquist plot (real component of the impedance) as the resistance value. Averaged values between forward and backward scans were taken as ORR and OER activity values. The results are shown in Table 4. This data shows significant variation between OER and ORR activity across the samples tested and that Example 1 has a significantly higher OER catalytic activity in comparison with the other samples, combined with an absence of ORR activity.

TABLE 4
Results of electrochemical testing of
Example 1 and Comparative Examples 1-3

| | ORR @ 0.8 V_{RHE} | OER @ 1.6 V_{RHE} |
|---|---|---|
| Sample | (mA/cm²) | (mA/cm²) |
| Example 1 | No activity | 2.3 |
| Comparative Example 1 | No activity | 0.48 |
| Comparative Example 2 | 0.16 | 0.63 |
| Comparative Example 3 | 0.53 | 0.41 |

1. A nickel-cobalt-oxide material of formula (1):
NiₓCo₃₋ₓO_{4-α} (1)
in which 0.5≤x≤2.0 and 0≤α≤1.0;
and wherein the nickel-cobalt-oxide material has a cobalt-enriched surface composition and the ratio of Co to Ni at the surface is greater than or equal to 3.0 as determined by XPS measurement.

2. A nickel-cobalt-oxide material according to claim 1, wherein the nickel-cobalt-oxide has a structure corresponding to the Fm-3m space group as determined by x-ray diffraction analysis (XRD).

3. A nickel-cobalt-oxide material according to claim 1, wherein 0.7≤x≤1.5, or preferably 0.8≤x≤1.2.

4. A nickel-cobalt-oxide material according to claim 1, wherein the nickel-cobalt-oxide material is in particle form with an average particle size in the range of and including 1 to 200 nm.

5. A nickel-cobalt-oxide material according to claim 1, wherein the ratio of Co to Ni at the surface is in the range of and including 3.0 to 5.0.

6. A nickel-cobalt-oxide material according to claim 1, wherein the bulk ratio of Co to Ni is less than 2.5, such as in the range of and including 0.5 to 2.5.

7. A composition comprising a nickel-cobalt-oxide material according to claim 1 and carbon.

8. A composition according to claim 7, wherein the carbon content of the composition is in the range of and including 1 to 20 wt %.

9-13. (canceled)

14. An electrode for water electrolysis comprising a nickel-cobalt-oxide material according to claim 1.

15-16. (canceled)

17. An electrode for water electrolysis according to claim 14, wherein the electrode is an anode catalyst layer of a water electrolyser using an alkaline electrolyte.

18. An electrode according to claim 14, wherein the electrode is an anode catalyst layer, and the anode catalyst layer is provided on a polymeric membrane permeable to hydroxide ions.

19. An electrode according to claim 14, wherein the electrode is an anode catalyst layer, wherein the anode catalyst layer is provided on a polymeric membrane permeable to hydroxide ions which has a first face and a second face, and wherein the anode layer is provided on the first face and a cathode layer comprising a hydrogen evolution catalyst is provided on the second face.
